(19) United States
(12) Patent Application Publication
(10) Pub. No.: US 2007/0080865 A1
(43) Pub. Date: Apr. 12, 2007

(54) ELECTRONIC APPARATUS WITH WIRELESS COMMUNICATION FUNCTION

(76) Inventors: Chiuan-Jian Huang, Taipei (TW); Ching-Chung Tang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,692

(22) Filed: Sep. 13, 2006

(30) Foreign Application Priority Data
Sep. 14, 2005 (TW) 94131599

(51) Int. Cl. H01Q 1/38

(52) U.S. Cl. 343/700 MS; 343/702

(57) ABSTRACT

An electronic apparatus with wireless communication function, including a first circuit board and a second circuit board, is provided. The first circuit board has a first feed pad and a first shorting pad on a first surface thereof, and has a signal line and a ground plane, electrically connected to the signal line and the ground plane respectively. Moreover, the second circuit board has a second feed pad and a second shorting pad on a second surface thereof, wherein the second surface is opposite to the first surface. Additionally, the second circuit board has a radiating patch on a third surface thereof. The second feed pad is electrically connected to the radiating patch and is bonded to the first feed pad. The second shorting pad is electrically connected to the radiating patch and is bonded to the first shorting pad.

### CROSS-REFERENCE TO RELATED APPLICATION

This application claims the priority benefit of Taiwan application serial no. 94131599, filed on Sep. 14, 2005. All disclosure of the Taiwan application is incorporated herein by reference.

### BACKGROUND OF THE INVENTION

1. Field of Invention

The present invention relates to an electronic apparatus, and more particularly to an electronic apparatus with wireless communication function.

2. Description of Related Art

In recent years, along with the rapid advancement of electronic industry, the sizes of electronic apparatuses and electronic devices are getting smaller and smaller. In terms of the wireless communication technology, size reduction and improved efficiency of the antenna used for wireless communication function are required to meet the requirements of miniaturization and large effect resonant bandwidth.

A well-known conventional antenna is generally printed directly on the motherboard, or is connected to the motherboard through an extra metal patch protruding from the antenna. However, the size of the conventional antenna is still very large or occupies large space; therefore, its efficiency is not ideal.

To reduce the size of antenna, the conventional technology has further came up with a planer inverted-F antenna (hereinafter after called “PIFA”), which includes a radiating patch, a feed via, a shorting via, and a ground plane, wherein the radiating patch is connected to a signal resource (e.g. a signal line) of the motherboard through the feed via and connected to the ground plane through the shorting via.

In the conventional PIFA, the radiating patch, shorting via, and ground plane of the PIFA are formed by a single metal component. Since a predetermined space is required to be placed between the radiating patch and the ground plane, an increase in the operation bandwidth of the PIFA requires an increase in the space between the radiating patch and the ground plane when the ground plane of the metal component is bonded to the circuit board. Accordingly, that the increase in the thickness of the electronic apparatus is disadvantageous to the miniaturization of the electronic apparatus.

### SUMMARY OF THE INVENTION

According to an objective of the present invention, an electronic apparatus with wireless communication function is provided to improve the wireless communication bandwidth thereof.

According to another objective of the present invention, an electronic apparatus with wireless communication function is provided to reduce the thickness of the antenna component thereof.

Based on the aforementioned or other objectives, the present invention provides an electronic apparatus with wireless communication function, which includes a first circuit board and a second circuit board. The first circuit board has a first feed pad and a first shorting pad on a first surface thereof, and the first circuit board further has a signal line and a ground plane, wherein the first feed pad and the first shorting pad are electrically connected to the signal line and the ground plane, respectively. In addition, the second circuit board has a second feed pad and a second shorting pad on a second surface thereof, opposite to the first surface. Additionally, the second circuit board has a radiating patch on a third surface thereof, opposite to the second surface, wherein the second feed pad is electrically connected to the radiating patch and bonded to the first feed pad, and the second shorting pad is electrically connected to the radiating patch and bonded to the first shorting pad.

According to an embodiment of the present invention, the said first circuit board further have a first feed via where the first feed pad is electrically connected to the signal line through the first feed via. Moreover, the said first circuit board have a first shorting via and the first shorting pad is electrically connected to the ground plane through the first shorting via.

According to an embodiment of the present invention, the said second circuit board further have a second feed via where the second feed pad is electrically connected to the radiating patch through the second feed via. Moreover, the said second circuit board further have a second shorting via where the second shorting pad is electrically connected to the radiating patch through the second shorting via.

According to an embodiment of the present invention, the said ground plane is located on a fourth surface of the first circuit board, opposite to the first surface.

According to an embodiment of the present invention, the second feed pad is bonded to the first feed pad by welding. In addition, the second shorting pad is bonded to the first shorting pad by welding.

According to an embodiment of the present invention, the said second circuit board is disposed on the first surface of the first circuit board by welding.

According to an embodiment of the present invention, the said signal line is a high frequency signal line and electrically connected to a high frequency signal area of the first circuit board.

According to an embodiment of the present invention, the ground plane is a ground plane of the first circuit board.

According to an embodiment of the present invention, the radiating patch is curve-shape.

As described above, according to the present invention, multiple components of the PIFA are integrated into two overlapping circuit boards, and the largest space between the radiating patch and the ground plane (i.e. the ground plane of a conventional PIFA) equals to the sum of the thicknesses of the circuit boards, and the required operation bandwidth can be achieved by changing the space between the radiating patch and the ground plane due to adjustment of the thicknesses of the circuit boards.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view showing all the components of an electronic apparatus with wireless communication function according to an embodiment of the present invention.

FIG. 2 is a comprehensive diagram of the electronic apparatus in FIG. 1.

### DESCRIPTION OF EMBODIMENTS

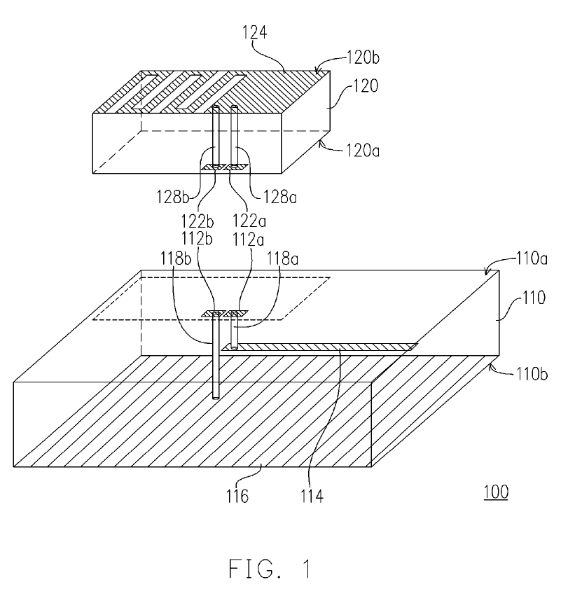

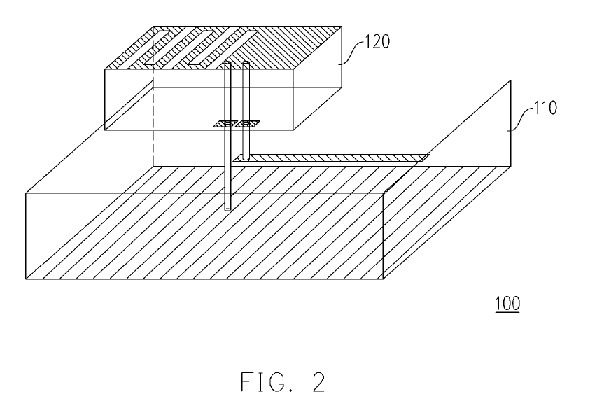

FIG. 1 is an exploded view showing all the components of an electronic apparatus with wireless communication function according to an embodiment of the present invention; FIG. 2 is a comprehensive diagram of the electronic apparatus in FIG. 1. Referring to FIGS. 1 and 2, the electronic apparatus 100 of the present embodiment includes a first circuit board 110 and a second circuit board 120, wherein the first circuit board 110 may be applied as a component carrier, and the second circuit board 120 may be applied as an antenna component.

The first circuit board 110 has a first feed pad 112a and a first shorting pad 112b, both disposed on a first surface 110a of the first circuit board 110. In addition, the first circuit board 110 has a signal line 114, and the first feed pad 112a is electrically connected to the signal line 114. The signal line 114 can be a high frequency signal line and is electrically connected to a high frequency signal area of the first circuit board 110. In order to electrically connect the first feed pad 112a to the signal line 114, the first circuit board 110 may further have a first feed via 118a, and the first feed pad 112a is electrically connected to the signal line 114 through the first feed via 118a.

The first circuit board 110 further have a ground plane 116 which may be a ground plane originally for the first circuit board 110, and is electrically connected to the first shorting pad 112b. In the present embodiment, the ground plane 116 is located on a fourth surface 110b of the first circuit board 110 opposite to the first surface 110a, or located inside the first circuit board 110. In order to electrically connect the first shorting pad 112b to the ground plane 116, the first circuit board 110 may further have a first shorting via 118b. The first shorting pad 112b is electrically connected to the ground plane 116 through the first shorting via 118b.

The second circuit board 120 has a second feed pad 122a and a second shorting pad 122b, both disposed on a second surface 120a of the second circuit board 120, wherein the second surface 120a of the second circuit board 120 is opposite to the first surface 110a of the first circuit board 110. The second circuit board 120 further has a radiating patch 124, disposed on a third surface 120b of the second circuit board 120 opposite to the second surface 120a, and electrically connected to the second feed pad 122a. In the present embodiment, the radiating patch 124 may be of curve shape or other shapes and the shape or pattern of the radiating patch 124 depends on the required efficiency of wireless communication.

In order to electrically connect the second feed pad 122a to the radiating patch 124, the second circuit board 120 may further have a second feed via 128a, and the second feed pad 122a is electrically connected to the radiating patch 124 through the second feed via 128a. In addition, in order to electrically connect the second shorting pad 122b to the radiating patch 124, the second circuit board 120 further has a second shorting via 128b, and the second shorting pad 122b is electrically connected to the radiating patch 124 through the second shorting via 128b.

When the second circuit board 120 is disposed on the first surface 110a of the first circuit board 110 and the second surface 120a of the second circuit board 120 is fastened to the first surface 110a of the first circuit board 110, the second feed pad 122a and the second shorting pad 122b are bonded to the first feed pad 112a and the first shorting pad 112b, respectively. In the present embodiment, the second circuit board 120 is disposed on the first surface 110a of the first circuit board 110 by welding, and the second feed pad 122a and the second shorting pad 122b are bonded to the first feed pad 112a and the first shorting pad 112b, respectively, by welding.

After disposing the second circuit board 120 on the first circuit board 110, the radiating patch 124 is electrically connected to the signal line 114 through the second feed via 128a, the second feed pad 122a, the first feed pad 112a, and the first feed via 118a sequentially. Meanwhile, the radiating patch 124 is electrically connected to the ground plane 116 through the second shorting via 128b, the second shorting pad 122b, the first shorting pad 112b, and the first shorting via 118b sequentially.

In view of the foregoing, compared to the conventional design of forming the radiating patch, shorting via, and ground plane of the PIFA with a metal patch and bonding them to the circuit board through the ground plane of the metal patch, the present embodiment integrates multiple components of the PIFA into two overlapping circuit boards to allow the largest space between the radiating patch and the ground plane (i.e. the ground plane of the conventional PIFA) equals to the sum of the thicknesses of the circuit boards; therefore, the required operation bandwidth can be achieved by changing the space between the radiating patch and the ground plane by adjusting the thicknesses of the circuit boards.

Additionally, according to the preferred embodiment of the present invention, the ground plane may also be disposed inside the circuit board or on a surface of the circuit board. When provided with the same operation bandwidth, the space between the radiating patch and the ground plane in the present invention is smaller compared to that of the conventional design of PIFA with metal patch. Accordingly, the preferred embodiment of the present invention is advantageous to the miniaturization of the electronic apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus with wireless communication function, comprising:
a first circuit board having a signal line and a ground plane, and having a first feed pad and a first shorting pad on a first surface thereof, wherein the first feed pad is electrically connected to the signal line, and the first shorting pad is electrically connected to the ground plane; and
a second circuit board having a second feed pad and a second shorting pad on a second surface thereof opposite to the first surface, and having a radiating patch on a third surface of the second circuit board opposite to the second surface, wherein the second feed pad is electrically connected to the radiating patch and bonded to the first feed pad, and the second shorting pad is electrically connected to the radiating patch and bonded to the first shorting pad.

2. The electronic apparatus according to claim 1, wherein the first circuit board has a first feed via, and the first feed pad is electrically connected to the signal patch through the first feed via.

3. The electronic apparatus according to claim 1, wherein the first circuit board has a first shorting via, and the shorting pad is electrically connected to the ground plane through the first shorting via.

4. The electronic apparatus according to claim 1, wherein the second circuit board has a second feed via, and the second feed pad is electrically connected to the radiating patch through the second feed via.

5. The electronic apparatus according to claim 1, wherein the second circuit board further has a second shorting via, and the second shorting pad is electrically connected to the radiating patch through the second shorting via.

6. The electronic apparatus according to claim 1, wherein the ground plane is located on a fourth surface of the first circuit board opposite to the first surface.

7. The electronic apparatus according to claim 1, wherein the second feed pad is bonded to the first feed pad by welding.

8. The electronic apparatus according to claim 1, wherein the second shorting pad is bonded to the first shorting pad by welding.

9. The electronic apparatus according to claim 1, wherein the second circuit board is disposed on the first surface of the first circuit board by welding.

10. The electronic apparatus according to claim 1, wherein the signal patch is a high frequency signal patch and electrically connected to a high frequency signal area of the first circuit board.

11. The electronic apparatus as claimed in claim 1, wherein the ground plane is a ground plane for the first circuit board.

12. The electronic apparatus as claimed in claim 1, wherein the radiating patch is curve-shape.
